(19) United States
(12) Patent Application Publication
(10) Pub. No.: US 2026/0105834 A1
(43) Pub. Date: Apr. 16, 2026

(54) INFORMATION PROCESSING DEVICE, SIGNAL CONTROL DEVICE, ACCUMULATION LENGTH ESTIMATING METHOD, SIGNAL CONTROL METHOD, AND COMPUTER PROGRAM

(71) Applicant: SUMITOMO ELECTRIC INDUSTRIES, LTD., Osaka-shi, Osaka (JP)

(72) Inventors: Shintaro MATSUMOTO, Osaka-shi, Osaka (JP); Toshiya YOSHIOKA, Osaka-shi, Osaka (JP); Shigeki NISHIMURA, Osaka-shi, Osaka (JP)

(73) Assignee: SUMITOMO ELECTRIC INDUSTRIES, LTD., Osaka-shi, Osaka (JP)

(21) Appl. No.: 19/114,797

(22) PCT Filed: Jul. 19, 2023
(86) PCT No.: PCT/JP2023/026349

§ 371 Date: Mar. 25, 2025

(30) Foreign Application Priority Data
Sep. 27, 2022 (JP) 2022-153574

(51) Int. Cl. G08G 1/01; G08G 1/083

(52) U.S. Cl. CPC G08G 1/0133; G08G 1/0112; G08G 1/0145; G08G 1/083

(57) ABSTRACT

An information processing device includes: a main road congestion degree estimation unit configured to estimate a degree of congestion on a predetermined section of a main road; and a queue length estimation unit configured to, based on the degree of congestion estimated by the main road congestion degree estimation unit, estimate a queue length on a rampway that branches off from the main road toward a signalized intersection leading to another road.

### TECHNICAL FIELD

The present disclosure relates to an information processing device, a signal control device, a queue length estimation method, a signal control method, and a computer program. This application claims priority on Japanese Patent Application No. 2022-153574 filed on Sep. 27, 2022, the entire content of which is incorporated herein by reference.

### BACKGROUND ART

Patent Literature 1 discloses a proposal for an actuated traffic signal (hereinafter referred to as “actuated signal”). The technology disclosed in Patent Literature 1 uses information acquired from a probe vehicle (hereinafter referred to as “probe information”). A probe vehicle is equipped with a GNSS (Global Navigation Satellite System) and a gyro sensor or the like, and is capable of storing therein time information, position information, traveling speed, traveling direction, etc., and transmitting them to the outside through wireless communication.

The technology disclosed in Patent Literature 1 estimates an end position of a traffic jam at an intersection, based on the distance from the intersection when a probe vehicle is stopped, the duration of red light at the intersection, and the elapsed time of red light when the vehicle is stopped. Similarly, the distance to an end position of a traffic jam on another intersecting road is estimated based on information acquired from the probe vehicle. The technology disclosed in Patent Literature 1 calculates signal parameters based on the ratio of the traffic jam end positions.

### CITATION LIST

### Patent Literature

PATENT LITERATURE 1: Japanese Laid-Open Patent Publication No. 2009-146138

### SUMMARY OF THE INVENTION

An information processing device according to one aspect of the present disclosure includes: a main road congestion degree estimation unit configured to estimate a degree of congestion on a predetermined section of a main road; and a queue length estimation unit configured to, based on the degree of congestion estimated by the congestion degree estimation unit, estimate a queue length on a road that branches off from the main road toward a signalized intersection leading to another road.

The present disclosure can be realized not only as an information processing device having the characteristic processing unit, but also as an information processing method, a queue length estimation method, or a signal control method having the characteristic processes as steps, or as a program for causing a computer to execute the steps. Moreover, the present disclosure can be realized as a semiconductor integrated circuit that realizes a part or the entirety of the information processing device, or as an information processing system or a signal control system including the information processing device.

### BRIEF DESCRIPTION OF DRAWINGS

FIG. 1 shows a schematic configuration of a signal control system according to a first embodiment of the present disclosure.

FIG. 2 is a block diagram showing a functional configuration of a signal control server included in the signal control system according to the first embodiment.

FIG. 3 is a flowchart showing a control configuration of a program that realizes a number-of-inflows calculation unit shown in FIG. 2.

FIG. 4 is a schematic diagram showing a configuration of a number-of-inflows storage unit shown in FIG. 2.

FIG. 5 is a flowchart showing a control configuration of a program that realizes a number-of-outflows calculation unit shown in FIG. 2.

FIG. 6 is a schematic diagram showing a configuration of a number-of-outflows storage unit shown in FIG. 2.

FIG. 7 is a flowchart showing a control configuration of a program that realizes a signal control unit shown in FIG. 2.

FIG. 8 shows a schematic configuration of a signal control system according to a second embodiment of the present disclosure.

FIG. 9 is a block diagram showing a functional configuration of a signal control server included in the signal control system shown in FIG. 8.

FIG. 10 is a flowchart showing a control configuration of a program that realizes a traffic condition prediction unit shown in FIG. 9.

FIG. 11 shows the appearance of the signal control server according to the first embodiment and the second embodiment.

FIG. 12 is a block diagram showing a hardware configuration of the signal control server according to the first embodiment and the second embodiment.

### DETAILED DESCRIPTION

### Problems to be Solved by the Present Disclosure

The technology described in Patent Literature 1 provides an effect that signal parameters can be calculated by using probe information even when a vehicle detector is not installed at a signalized intersection.

Meanwhile, for vehicles that exit from the main road of an expressway or the like and enter a general road, a road (called “rampway”) connecting these roads is provided. At an intersection between the rampway and the general road, traffic signals are usually installed. If a traffic jam occurs on the rampway, the main road is sometimes affected by the traffic jam. Therefore, a traffic signal at the exit of the rampway is preferably an actuated traffic signal. However, because of the complicated shape of the rampway, a vehicle detector cannot be installed on the rampway in many cases. Therefore, it is difficult to install an actuated traffic signal at the intersection at the exit of the rampway.

If a probe vehicle is present on the rampway, the technology of Patent Literature 1 can be used. However, there is no guarantee that a probe vehicle is always present on the rampway. Therefore, it is preferable if the traffic signal at the exit of the rampway can be operated as an actuated traffic signal even when a probe vehicle is not present.

Therefore, an object of the present disclosure is to provide an information processing device, a signal control device, a queue length estimation method, a signal control method, and a computer program that can grasp the traffic condition on a rampway without a vehicle detector installed on the rampway.

### Effects of the Present Disclosure

As described above, according to the present disclosure, it is possible to provide an information processing device, a signal control device, a queue length estimation method, a signal control method, and a computer program that can grasp the traffic condition on a rampway without a vehicle detector installed on the rampway.

### DESCRIPTION OF EMBODIMENTS OF THE PRESENT DISCLOSURE

In the description below and the drawings, the same components are denoted by the same reference signs. Therefore, detailed descriptions thereof are not repeated. At least some parts of the embodiments described below may be combined together as desired.
(1) An information processing device according to a first aspect of the present disclosure includes: a main road congestion degree estimation unit configured to estimate a degree of congestion on a predetermined section of a main road; and a queue length estimation unit configured to, based on the degree of congestion estimated by the main road congestion degree estimation unit, estimate a queue length on a rampway that branches off from the main road toward a signalized intersection leading to another road.

The main road congestion degree estimation unit estimates the degree of congestion on the main road. The queue length estimation unit estimates the queue length as an index of the degree of congestion on the rampway, based on the estimated degree of congestion on the main road. Information for controlling a traffic signal at the exit of the rampway as an actuated traffic signal can be generated without necessity of installing a vehicle detector on the rampway.
(2) In the above (1), the main road congestion degree estimation unit may include a unit time congestion degree estimation unit configured to, based on at least the number of inflow vehicles per unit time into the predetermined section, estimate the degree of congestion on the predetermined section in each unit time.

It is conceivable that there is a correlation between the number of inflow vehicles per unit time into the predetermined section and the number of vehicles on the rampway. Therefore, the degree of congestion on the rampway can be estimated from the number of inflow vehicles.
(3) In the above (2), the unit time congestion degree estimation unit may include: a number-of-inflows calculation unit configured to calculate the number of inflow vehicles into the predetermined section in each unit time; a number-of-outflows calculation unit configured to calculate the number of outflow vehicles from the predetermined section in each unit time; and a section congestion degree estimation unit configured to estimate the degree of congestion on the predetermined section, based on a difference between the number of inflow vehicles per unit time calculated by the number-of-inflows calculation unit and the number of outflow vehicles per unit time calculated by the number-of-outflows calculation unit.

The number of vehicles that have entered the rampway from the main road can be estimated with high reliability, based on the difference between the number of inflow vehicles into the predetermined section and the number of outflow vehicles from the predetermined section. Therefore, based on the result of the estimation, the degree of congestion on the rampway can be estimated with high reliability.
(4) In the above (3), the number-of-inflows calculation unit may calculate the number of inflow vehicles into the predetermined section in each unit time, based on an output of a vehicle detector installed on an upstream side with respect to the predetermined section.

The number of inflow vehicles into the predetermined section can be counted with high reliability, based on the output of the vehicle detector installed on the upstream side. As a result, the degree of congestion on the main road can be estimated with high reliability. Since the degree of congestion on the rampway is estimated based on the degree of congestion on the main road, the reliability is enhanced.
(5) In the above (3), the number-of-inflows calculation unit may calculate a predicted number of inflow vehicles into the predetermined section in each unit time, based on, in addition to the output of the vehicle detector installed on the upstream side, an output of an upstream vehicle detector that is located further upstream than the vehicle detector installed on the upstream side.

The number of vehicles that will enter the predetermined section in the future can be estimated based on the output of the upstream vehicle detector that is located further upstream than the vehicle detector installed on the upstream side. By correcting the output of the vehicle detector installed on the upstream side by using the estimated value, the degree of congestion on the main road can be predicted using the predicted number of vehicles as well as the number of inflow vehicles into the predetermined section. Since the degree of congestion on the rampway is estimated using the degree of congestion on the main road, delay in estimating the degree of congestion can be reduced.
(6) In any one of the above (3) to (5), the number-of-outflows calculation unit may calculate the number of outflow vehicles from the predetermined section in each unit time, based on an output of a vehicle detector installed on a downstream side with respect to the predetermined section.

It is conceivable that there is a correlation between the number of outflow vehicles counted by the vehicle detector installed on the downstream side and the number of vehicles that enter the rampway. Therefore, the degree of congestion on the rampway can be estimated by using the output of the downstream-side vehicle detector installed on the main road, without installing a vehicle detector on the rampway.
(7) In any one of the above (1) to (6), the main road congestion degree estimation unit may further include a connection area congestion degree estimation unit configured to determine that the main road is congested, based on the state of a first probe vehicle in a connection area where the rampway branches off from the main road.

When the first probe vehicle is present in the connection area where the rampway branches off from the main road, the moving speed, the stop time, etc., of a vehicle present near the connection area can be estimated based on probe information obtained from the probe vehicle. These have a strong correlation with the degree of congestion on the rampway. Therefore, estimation of the degree of congestion on the rampway can be corrected by using the probe information, thereby enhancing the reliability of estimation.
(8) In any one of the above (1) to (7), the information processing device may further include a rampway queue length correction unit configured to correct a queue length on the rampway, based on vehicle state information of a second probe vehicle present on the rampway.

If a probe vehicle is present on the rampway, the queue length on the rampway can be estimated by using probe information of the probe vehicle. By correcting the queue length using the estimated value, the accuracy in estimating the degree of congestion on the rampway can be enhanced.
(9) In any one of the above (1) to (8), the information processing device may further include a signal control unit configured to control a period or a split of a phase of a traffic signal, based on the queue length estimated by the queue length estimation unit.

Even when a vehicle detector is not installed on the rampway, the traffic signal installed at the exit of the rampway can be controlled as an actuated traffic signal. The traffic signal can be appropriately controlled according to the conditions on both the rampway and the general road.
(10) In the above (9), the signal control unit may control the period or the split of the phase of the traffic signal, based on the queue length estimated by the queue length estimation unit, and a queue length on the other road at the signalized intersection.

The queue length on the rampway can be estimated without installing a vehicle detector on the rampway. Using the result of the estimation and the traffic condition on the general road, signal parameters are generated. As a result, the traffic signal installed at the exit of the rampway can be controlled as an actuated traffic signal. The traffic signal can be appropriately controlled according to the conditions on both the rampway and the general road.
(11) In any one of the above (1) to (10), the main road congestion degree estimation unit may include a rampway-side lane congestion degree estimation unit configured to estimate the degree of congestion on a lane on the rampway side in the predetermined section.

If the predetermined section has a plurality of lanes, a vehicle attempting to enter the rampway should have moved to a lane on the rampway side before entering the rampway. Therefore, there is a correlation between the degree of congestion of vehicles on the rampway-side lane, and the degree of congestion on the rampway. The traffic condition on the rampway can be estimated by using the output of the vehicle detector for the rampway-side lane of the main road. As a result, the traffic condition on the rampway can be estimated without installing a vehicle detector on the rampway.
(12) In any one of the above (1) to (11), the unit time may be a time equal to or shorter than two periods and equal to or longer than one period of a cycle of a traffic signal at the signalized intersection.

If the unit time is too long, appropriate signal control cannot be performed. Meanwhile, if the unit time is shorter than one period, the operation of the traffic signal will change before one cycle of the traffic signal is completed, which is undesirable. Therefore, the unit time is preferably equal to or shorter than two periods and equal to or longer than one period of the cycle of the traffic signal, for example, is equal to two periods or one period.
(13) In the above (12), the unit time may be a time equal to one period of the cycle of the traffic signal at the signalized intersection.

By making the unit time equal to one period of the cycle of the traffic signal, it is possible to quickly respond to a change in the traffic volume. Moreover, the operation of the traffic signal will not change in the middle of the cycle.
(14) A signal control device according to a second aspect of the present disclosure includes: a main road congestion degree estimation unit configured to estimate a degree of congestion on a predetermined section of a main road; a queue length estimation unit configured to, based on the degree of congestion estimated by the main road congestion degree estimation unit, estimate a queue length on a rampway that branches off from the main road toward a signalized intersection leading to another road; and a signal control unit configured to control a period or a split of a phase of a traffic signal, based on the queue length estimated by the queue length estimation unit.

The main road congestion degree estimation unit estimates the degree of congestion on the main road. The queue length estimation unit estimates the queue length as an index of the degree of congestion on the rampway, based on the estimated degree of congestion on the main road. The signal control unit controls the period or the split of the phase of the traffic signal based on the queue length. The traffic signal at the exit of the rampway can be controlled as an actuated traffic signal without necessity of installing a vehicle detector on the rampway.
(15) A queue length estimation method according to a third aspect of the present disclosure includes the steps of: estimating, by a computer, a degree of congestion on a predetermined section of a main road; and, based on the degree of congestion estimated in the step of estimating the degree of congestion, estimating, by the computer, a queue length on a rampway that branches off from the main road toward a signalized intersection leading to another road.

The degree of congestion on the main road is estimated in the step of estimating the degree of congestion on the predetermined section of the main road. In the step of estimating the queue length, the queue length as an index of the degree of congestion on the rampway is estimated based on the estimated degree of congestion on the main road. Information required for controlling the traffic signal at the exit of the rampway as an actuated traffic signal can be generated without necessity of installing a vehicle detector on the rampway.
(16) A signal control method according to a fourth aspect of the present disclosure includes the steps of: estimating, by a computer, a degree of congestion on a predetermined section of a main road; based on the degree of congestion estimated in the step of estimating the degree of congestion, estimating, by the computer, a queue length on a rampway that branches off from the main road toward a signalized intersection leading to another road; and controlling, by the computer, a period or a split of a phase of a traffic signal installed in the signalized intersection, based on the queue length estimated in the step of estimating the queue length.

The computer estimates the degree of congestion on the main road in the step of estimating the degree of congestion on the predetermined section of the main road. In the step of estimating the queue length, the computer estimates the queue length as an index of the degree of congestion on the rampway, based on the estimated degree of congestion on the main road. The computer can generate information required for controlling the traffic signal at the exit of the rampway as an actuated traffic signal, without necessity of installing a vehicle detector on the rampway.
(17) A computer program according to a fifth aspect of the present disclosure causes a computer to function as: a main road congestion degree estimation unit configured to estimate a degree of congestion on a predetermined section of a main road; and a queue length estimation unit configured to, based on the degree of congestion estimated by the main road congestion degree estimation unit, estimate a queue length on a rampway that branches off from the main road toward a signalized intersection leading to another road.

The computer executes the computer program, whereby the computer functions as the main road congestion degree estimation unit, and estimates the degree of congestion on the main road. Furthermore, the computer functions as the queue length estimation unit, and estimates the queue length as an index of the degree of congestion on the rampway, based on the estimated degree of congestion on the main road. The computer can generate information for controlling the traffic signal at the exit of the rampway as an actuated traffic signal, without necessity of installing a vehicle detector on the rampway.

### DETAILS OF EMBODIMENTS OF THE PRESENT DISCLOSURE

Hereinafter, specific examples of an information processing device, a signal control device, a queue length estimation method, a signal control method, and a computer program according to embodiments of the present disclosure will be described with reference to the drawings. The present disclosure is not limited to these examples and is indicated by the claims, and is intended to include meaning equivalent to the claims and all modifications within the scope of the claims.

### 1. First Embodiment

### 1.1) Configuration

### a) Overall Configuration

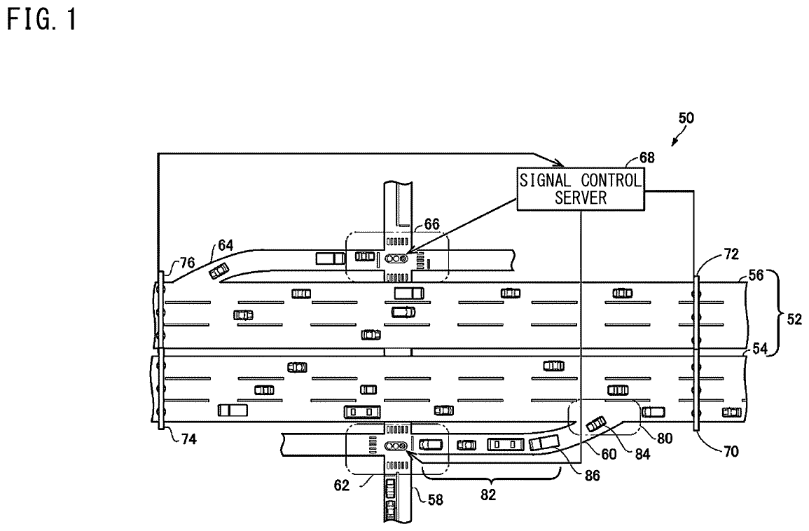

With reference to FIG. 1, a signal control system 50 according to the first embodiment of the present disclosure has the function of detecting the traffic state on a rampway 60 that branches off from a motor highway 52 and leads to a general road 58. At an intersection between the rampway 60 and the general road 58, a traffic signal 62 is installed. The motor highway 52 has a first-direction road 54 and a second-direction road 56. The rampway 60 connects the first-direction road 54 and the general road 58. The second-direction road 56 is provided with another rampway 64. The rampway 64 connects the second-direction road 56 and the general road 58. A traffic signal 66 is also installed at an intersection between the rampway 64 and the general road 58.

On the first-direction road 54, a vehicle detector 70 is installed on the upstream side with respect to the rampway 60. A vehicle detector 74 is installed on the downstream side with respect to the rampway 60. In this specification, “upstream” with respect to a certain point on a road refers to a part, of the road, which has yet to be reached by a vehicle traveling in a vehicle advancing direction that is set on the road, and “downstream” refers to a part, of the road, which has already been reached by the vehicle. That is, these terms are used in the same way as “upstream” and “downstream” in relation to the flow of water in a river.

Similarly, on the second-direction road 56, a vehicle detector 76 is installed on the upstream side with respect to the rampway 60. The vehicle detector 76 is installed at the same position as the vehicle detector 74. A vehicle detector 72 is installed on the downstream side with respect to the rampway 60 on the second-direction road 56. The vehicle detector 72 is installed at the same position as the vehicle detector 70.

The first-direction road 54 and the second-direction road 56 each have three lanes. The vehicle detector 70 and the vehicle detector 74 each have the function of independently detecting vehicles traveling on the lanes of the first-direction road 54, and outputting detection signals. The vehicle detector 72 and the vehicle detector 74 each have the function of independently detecting vehicles traveling on the lanes of the second-direction road 56, and outputting detection signals.

The signal control system 50 estimates the traffic conditions on the rampway 60 and the rampway 64 by using the vehicle detector 70, the vehicle detector 72, the vehicle detector 74, and the vehicle detector 76, and lane-specific vehicle detection signals obtained from these detectors. When probe vehicles are present on the rampway 60 and the rampway 64, the signal control system 50 uses probe information obtained from these probe vehicles as well to estimate the traffic conditions on the rampway 60 and the rampway 64. The signal control system 50 controls the traffic signal 62 and the traffic signal 66, based on the results of the estimation and the traffic condition on the general road 58.

For example, while the traffic signal 62 is showing red light, a queue of retention vehicles 82 is formed within the rampway 60. There is no problem if all the vehicles in the queue of retention vehicles 82 exit onto the general road 58 during the next green light interval of the traffic signal 62. However, if some of the vehicles in the queue of retention vehicles 82 cannot exit the rampway 60 during the green light interval, a traffic jam occurs on the rampway 60. If the length of the traffic jam is long, the traffic jam may adversely affect the main road, i.e., the first-direction road 54. It is necessary to avoid occurrence of a traffic jam on the general road 58 as well. Therefore, the purpose of this embodiment is to appropriately operate the traffic signal 62 as an actuated traffic signal, based on the degree of congestion on the rampway 60 and the degree of congestion on the general road 58.

In this embodiment, as described above, the signal control system 50 controls not only the traffic signal 62 but also the traffic signal 66. Furthermore, the signal control system 50 may control other traffic signals in some cases. However, in order to simplify the description, only the control of the traffic signal 62 by the signal control system 50 will be described below. The parts related to the control of the traffic signal 66 and the other traffic signals will not be mentioned in the following description. It will be easily understood that the signal control system 50 can also control the traffic signal 66 and the other traffic signals in a manner similar to that described below.

The signal control system 50 includes a signal control server 68 that controls the traffic signal 62, based on a vehicle detection signal from the vehicle detector 70 and a vehicle detection signal from the vehicle detector 74, and on probe information from probe vehicles (e.g., probe vehicles 84 and 86 shown in FIG. 1) if such probe vehicles are present on the rampway 60. If the signal control system 50 also controls a traffic signal other than the traffic signal 62, a configuration similar to that of the signal control server 68 described below may be provided in parallel.

### b) Signal Control Server 68

The signal control server 68 is shown as a single computer in FIG. 1. However, in actuality, the signal control server 68 may be a plurality of computers connected in parallel, or may have a configuration in which processes are distributed to be executed by a so-called cloud that consists of a plurality of remote servers, and the signal control server 68 receives the results.

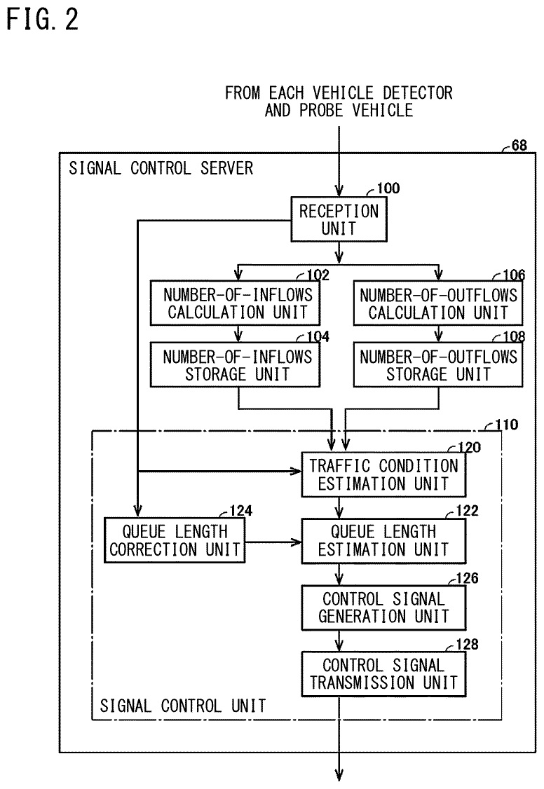

With reference to FIG. 2, the signal control server 68 includes a reception unit 100 that receives the vehicle detection signals from the vehicle detector 70 and the vehicle detector 74 shown in FIG. 1, and probe information from probe vehicles if such probe vehicles are present on the rampway 60. The reception unit 100 receives the signals through wired communication in this embodiment. However, the reception unit 100 may use wireless communication instead of or in addition to the wired communication. Vehicles from the upstream side pass through the vehicle detector 70 and flow in an area between the vehicle detector 70 and the vehicle detector 74 on the first-direction road 54, and the vehicles flow out from the area through the vehicle detector 74 or via the rampway 60. In the following description, the vehicles from the upstream side that pass through the vehicle detector 70 and flow in this area are referred to as “inflow vehicles”, and the number of such inflow vehicles is referred to as “number of inflow vehicles” or simply as “number of inflows”. In addition, vehicles that pass through the vehicle detector 74 and flow out from this area are referred to as “outflow vehicles”, and the number of such outflow vehicles is referred to as “number of outflow vehicles” or simply as “number of outflows”. Vehicles that flow out from this area via the rampway 60 are not included in the number of outflow vehicles.

The signal control server 68 further includes a number-of-inflows calculation unit 102 and a number-of-inflows storage unit 104. The number-of-inflows calculation unit 102 selectively captures vehicle detection signals from the vehicle detector 70, i.e., detection signals of inflow vehicles, from among vehicle detection signals received by the reception unit 100, and performs a process of calculating the number of inflow vehicles for each predetermined time interval. The number-of-inflows storage unit 104 stores, for each predetermined time interval, the number of inflow vehicles calculated by the number-of-inflows calculation unit 102. The number-of-inflows storage unit 104 stores the number of inflow vehicles for each of the most recent multiple time intervals. The control configuration of a program that realizes the number-of-inflows calculation unit 102 and the configuration of the number-of-inflows storage unit 104 will be described later. In the following description, the predetermined time interval is 10 seconds. Of course, this time interval may have any length. In this embodiment, a time consisting of a predetermined number of consecutive time intervals is set as a unit time for calculating control parameters of the traffic signal 62. For example, this unit time is selected to be equal to a cycle period of the traffic signal 62. Of course, this is just one example, and it is not necessary to select the unit time to be the same as the cycle period of the traffic signal 62. However, as described below, in this embodiment, the split or the cycle period of the traffic signal 62 may be changed. Therefore, in order to prevent the split from being changed in the middle of one cycle, the unit time is preferably a positive integral multiple of the cycle period of the traffic signal 62. If the cycle period is changed, it is desirable to change the unit time accordingly.

The signal control server 68 further includes a number-of-outflows calculation unit 106 and a number-of-outflows storage unit 108. The number-of-outflows calculation unit 106 selectively captures vehicle detection signals from the vehicle detector 74, i.e., detection signals of outflow vehicles, from among vehicle detection signals received by the reception unit 100, and performs a process of calculating the number of outflow vehicles for each predetermined time interval. The number-of-outflows storage unit 108 stores, for each predetermined time interval, the number of outflow vehicles calculated by the number-of-outflows calculation unit 106. The number-of-outflows storage unit 108 stores the number of outflow vehicles for each of the most recent multiple time intervals. The control configuration of a program that realizes the number-of-outflows calculation unit 106 and the configuration of the number-of-outflows storage unit 108 will be described later.

The signal control server 68 further includes a signal control unit 110. The signal control unit 110 is connected to the number-of-inflows storage unit 104 and the number-of-outflows calculation unit 106. The signal control unit 110 generates a control signal for the traffic signal 62, based on the number of inflow vehicles and the number of outflow vehicles stored in these storage units, and on, if any, probe information received by the reception unit 100, and transmits the control signal to the traffic signal 62.

The signal control unit 110 includes a traffic condition estimation unit 120 and a queue length estimation unit 122. The traffic condition estimation unit 120 estimates the congestion state of the main road, i.e., the first-direction road 54, based on the number of inflows in the most recent past unit time stored in the number-of-inflows storage unit 104 and the number of outflows in the most recent past unit time stored in the number-of-outflows storage unit 108, and on, if any, probe information received by the reception unit 100. The queue length estimation unit 122 estimates the queue length on the rampway 60, based on the congestion state of the main road estimated by the traffic condition estimation unit 120. The “queue length” usually refers to the length of a line of vehicles stopped in front of a traffic signal while the traffic signal is showing red light. In this specification, however, the “queue length” refers to the length of a line of vehicles stopped due to the traffic signal at a point in time when estimation is performed by the queue length estimation unit 122.

The signal control unit 110 further includes a queue length correction unit 124 and a control signal generation unit 126. The queue length correction unit 124, if necessary, corrects the queue length estimated by the queue length estimation unit 122, in response to that probe information from a probe vehicle present on the rampway 60 has been received through the reception unit 100. The control signal generation unit 126 generates signal parameters of the traffic signal 62, based on the queue length estimated by the queue length estimation unit 122, and the output of the vehicle detector installed on the general road 58. The signal control unit 110 further includes a control signal transmission unit 128 for transmitting the signal parameters generated by the control signal generation unit 126 to the traffic signal 62.

### b1) Number-of-Inflows Calculation Unit 102

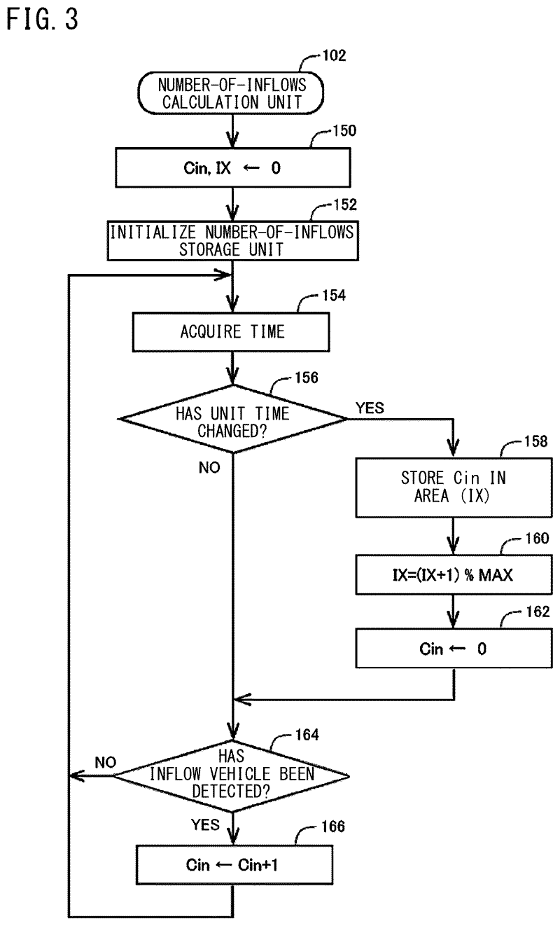

FIG. 3 shows, in a flowchart format, a control configuration of a program that realizes the number-of-inflows calculation unit 102 shown in FIG. 2. With reference to FIG. 3, this program includes: step 150 of initializing, to 0, a variable Cin for counting the number of inflow vehicles in a predetermined time interval and a variable IX as an index of a storage area in the number-of-inflows storage unit 104; and step 152 of initializing the storage area in the number-of-inflows storage unit 104. This program further includes: step 154 of acquiring the current time; and step 156 of determining whether or not the current time acquired in step 154 has exceeded a boundary of the predetermined time interval described above, and causing the flow of the control to diverge according to the result of the determination. As described later, the number-of-inflows storage unit 104 includes a plurality of storage areas. The variable IX is an index for accessing a specific area among the storage areas.

The process in step 156 is as follows. In this embodiment, an example of the predetermined time interval is 5 seconds. That is, the number of inflow vehicles is counted every 5 seconds. For example, if the preceding time interval is from 9:00:00 to 9:00:05, the next time interval is from 9:00:05 to 9:00:10. The boundary is a boundary at which the time interval changes, and is 9:00:05 in this example. In this present embodiment, the boundary belongs to the preceding time interval. That is, the time before 9:00:05 is the preceding time interval, and the time after 9:00:05 is the next time interval. The same applies hereinafter. In step 156, it is determined whether or not this boundary has been exceeded.

The length of this time interval can be freely set. However, it is desirable to select the length of the time interval such that the length can divide the cycle of the traffic signal to be controlled.

This program further includes: step 158 of storing the value of the variable Cin in the area (IX) in the number-of-inflows storage unit 104 in response to that the determination in step 156 is positive; step 160 of adding 1 to the value of the variable IX, executing a modulo operation (indicated by an operator “%”) with a constant MAX, and updating the value of the variable IX according to the result of the modulo operation; and step 162 of clearing the value of the variable Cin to 0. The constant MAX is equal to the number of areas used in the number-of-inflows storage unit 104. That is, the constant MAX is “the maximum value of index+1”, which is 24 in this example.

This program further includes: step 164, which is executed when the determination in step 156 is negative or when the determination in step 156 is positive and the processes from step 158 to step 162 have been executed, of determining whether or not a signal indicating that an inflow vehicle has been detected is received from the vehicle detector 70 via the reception unit 100, and causing the flow of the control to diverge according to the result of the determination; and step 166 of returning the control to step 154 by adding 1 to the variable Cin in response to that the determination in step 164 is positive. When the determination in step 164 is negative, the control returns to step 154.

### b2) Number-of-Inflows Storage Unit 104

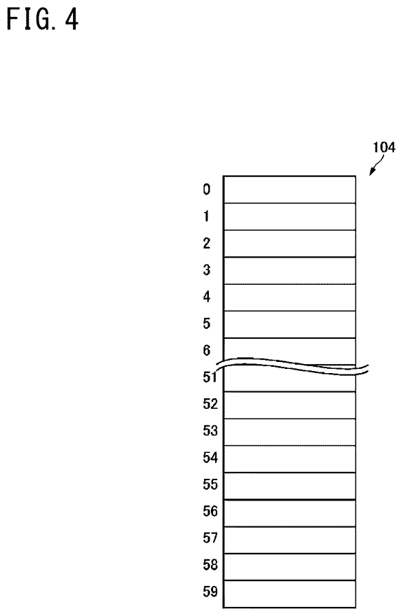

With reference to FIG. 4, the number-of-inflows storage unit 104 in this embodiment is divided into 60 storage areas. Each storage area corresponds to the predetermined time interval. However, not all the storage areas are necessarily used. In this embodiment, only a portion of these storage areas corresponding to the period of the signal cycle is used. For example, if the predetermined time is 5 seconds as described above and the period of the signal cycle is 120 seconds, 24 storage areas corresponding to 120 seconds are used out of the 60 storage areas in the number-of-inflows storage unit 104. An index IX is used to access each storage area. That is, the number of inflow vehicles counted during the first 5 seconds of each signal cycle is stored in an area (0), the number of inflow vehicles counted during the next 5 seconds is stored in an area (1), and similarly, the number of inflow vehicles counted during the last 5 seconds of the signal cycle is stored in an area (23). Then, when the next signal cycle begins, the number of inflow vehicles counted during the first 5 seconds of this signal cycle is again stored in the area (0). Thereafter, this process is repeated.

### b3) Number-of-Outflows Calculation Unit 106

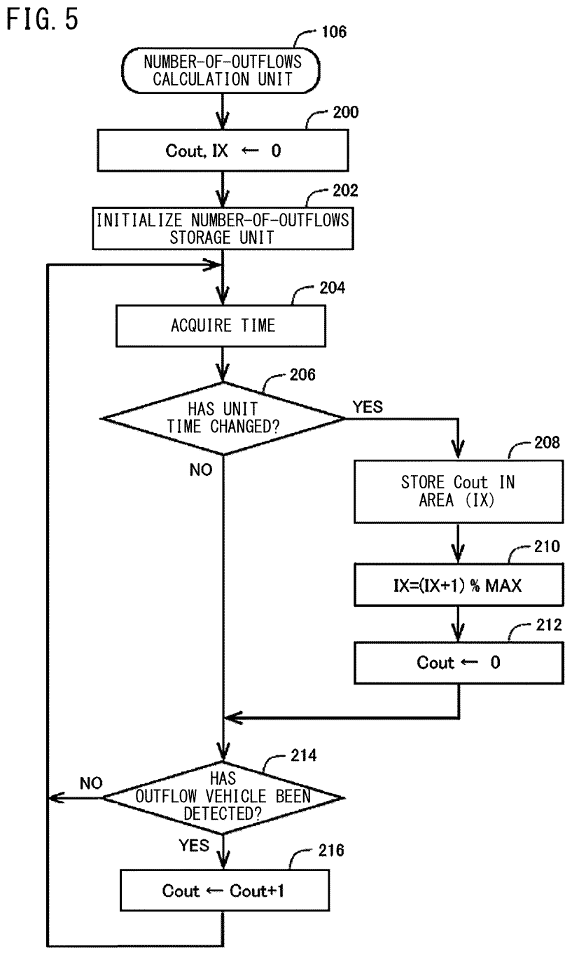

FIG. 5 shows a control configuration of a program that realizes the number-of-outflows calculation unit 106. The control configuration of this program is similar to that shown in FIG. 3.

That is, with reference to FIG. 5, this program includes: step 200 of initializing, to 0, a variable Cout for counting the number of outflow vehicles in a predetermined time interval and a variable IX as an index of a storage area in the number-of-outflows storage unit 108; and step 202 of initializing the storage area in the number-of-outflows storage unit 108. This program further includes: step 204 of acquiring the current time; and step 206 of determining whether or not the current time acquired in step 204 has exceeded the boundary of the predetermined time interval described above, and causing the flow of the control to diverge according to the result of the determination. As described later, the number-of-outflows storage unit 108 includes a plurality of storage areas. The variable IX is an index for accessing a specific area among the storage areas.

This program further includes: step 208 of, in response to that the determination in step 206 is positive, storing the value of the variable Cout in an area (IX) in the number-of-outflows storage unit 108; step 210 of adding 1 to the value of the variable IX, and executing a mod operation with the MAX to update the value of the variable IX; and step 212 of clearing the value of the variable Cout to 0.

This program further includes: step 214, which is executed when the determination in step 206 is negative or when the determination in step 206 is positive and the processes from step 208 to step 212 have been executed, of determining whether or not a signal indicating that an outflow vehicle has been detected is received from the vehicle detector 70 via the reception unit 100, and causing the flow of the control to diverge according to the result of the determination; and step 216 of returning the control to step 204 by adding 1 to the variable Cout in response to that the determination in step 214 is positive. When the determination in step 214 is negative, the control returns to step 204.

### b4) Number-of-Outflows Storage Unit 108

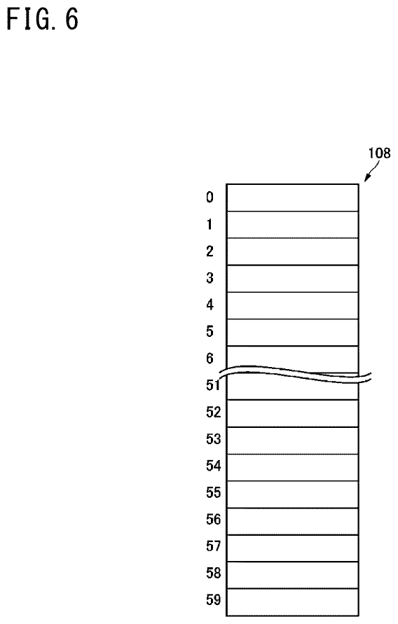

FIG. 6 shows the configuration of the number-of-outflows storage unit 108. The number-of-outflows storage unit 108 has completely the same configuration as the number-of-inflows storage unit 104 shown in FIG. 4. That is, the number-of-outflows storage unit 108 has 60 areas indicated by indices 0 to 59.

### b5) Signal Control Unit 110

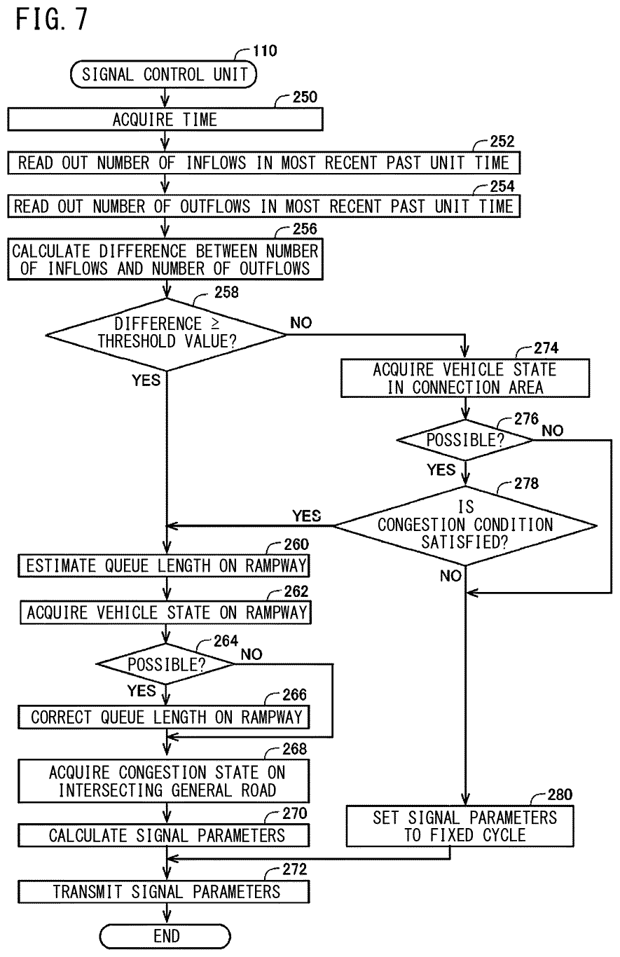

FIG. 7 shows, in a flowchart format, a control configuration of a program that realizes the signal control unit 110. This program is activated for each fixed time period, e.g., each period of the cycle of the traffic signal to be controlled. In this embodiment, this program is activated every 120 seconds to calculate signal parameters.

With reference to FIG. 7, this program includes: step 250 of acquiring the current time; and step 252 of reading out the number of inflows in the most recent past unit time from the number-of-inflows storage unit 104. In this embodiment, the unit time is 120 seconds that is the cycle time of the traffic signal 62. In the number-of-inflows storage unit 104, the number of inflows for the most recent past 120 seconds is stored. Therefore, by reading out all the numbers of inflows stored in the number-of-inflows storage unit 104 and calculating their sum, the number of inflow vehicles in the most recent past unit time (120 seconds) can be calculated.

This program further includes: step 254, similar to step 252, of reading out the number of outflow vehicles in the past unit time from the number-of-outflows calculation unit 106; step 256 of calculating a difference between the number of inflow vehicles obtained in step 252 and the number of outflow vehicles obtained in step 254; and step 258 of causing the flow of the control to diverge according to whether or not the difference calculated in step 256 is equal to or larger than a predetermined threshold value. When the determination in step 258 is positive, it is determined that the first-direction road 54 is congested.

In the present embodiment, as described above, whether or not the first-direction road 54 is congested is measured in only two levels (congested, not congested). However, the present disclosure is not limited to such an embodiment. The degree of congestion may be classified into a plurality of levels by using a plurality of threshold values.

This program further includes step 274 of, in response to that the determination in step 258 is positive, attempting to acquire the vehicle state in a connection area 80 (see FIG. 1) between the first-direction road 54 and the rampway 60. Specifically, in step 274, whether or not probe information has been received from any probe vehicle is determined, and if probe information has been received, whether or not the position of the corresponding probe vehicle is inside the connection area 80 is determined.

This program further includes: step 276 of, based on the result of the process in step 274, determining whether or not the vehicle state has been received, and causing the flow of the control to diverge according to the result of the determination; and step 278 of, in response to that the determination in step 276 is positive, determining whether or not the vehicle state satisfies a congestion condition, and causing the flow of the control according to the result of the determination. The congestion condition used in step 278 is, for example, whether or not the moving speed of the probe vehicle is equal to or lower than a threshold value (e.g., 15 km/h), whether or not the vehicle position is unchanged over a predetermined time period (e.g., 1 minute), or the like. In the former case, the moving speed may be the individual vehicle speed or the statistical speed. In the latter case, it is assumed that the movement trajectory of the probe vehicle can be obtained from the probe information. Even when the determination in step 258 is negative, if the determinations in step 276 and step 278 are both positive, the first-direction road 54 is determined to be congested.

This program further includes step 260 of, in response to that the determination in step 258 is positive or the determination in step 278 is positive, determining that the rampway 60 is congested, and estimating a queue length as an index indicating congestion on the rampway 60. In step 260, the queue length is estimated with the difference calculated in step 256 being the number of vehicles, and the average space headway being 7 m, for example. In calculating signal parameters described later, this queue length and the length of the rampway 60 are important inputs.

This program further includes step 262 of attempting acquisition of probe information from a probe vehicle present on the rampway 60. This program further includes: step 264 of causing the flow of the control to diverge according to whether or not probe information from a probe vehicle present on the rampway 60 has been acquired as the result of the process in step 262; and step 266 of, in response to that the determination in step 264 is positive, correcting the queue length estimated in step 260, by using the probe information obtained in step 262.

An example of the correction performed in step 266 is as follows. For example, it is assumed that a value of 10 (vehicles) has been calculated as a difference. In this case, an estimated queue length is 70 m. If the probe information reveals that the stop position of the probe vehicle is 90 m from the head of the line of vehicles, the estimated queue length is too short. Therefore, the signal control unit 110 corrects the queue length to 90 m in step 266. This is because it is known that the actual queue length is at least 90 m. Conversely, if the position of the probe vehicle is closer to the head than the estimated queue length, the signal control unit 110 maintains the estimated queue length. This is because the probe vehicle is not necessarily present at the tail of the line of vehicles.

This program further includes: step 268 of, in response to that step 266 has been completed or that the determination in step 264 is negative, acquiring the congestion state on the intersecting general road 58 from information from the vehicle detector installed on the general road 58; step 270 of calculating signal parameters according to a method similar to the ordinary actuated control, by using the information obtained in the processes in steps 262 to 268; and step 272 of transmitting the calculated signal parameters to the traffic signal 62 to end execution of this program.

This program further includes step 280 of, in response to that the determination in step 276 or step 278 is negative, setting the signal parameters for the traffic signal 62 to fixed-cycle parameters prepared in advance, and shifting the control to step 272.

### 1.2) Operation

The signal control system 50 according to the aforementioned first embodiment operates as follows.

When signal control is started in the signal control server 68 shown in FIG. 1, the program for the number-of-inflows calculation unit 102 shown in FIG. 3, the program for the number-of-inflows storage unit 104 shown in FIG. 5, and the program for the signal control unit 110 shown in FIG. 7 are activated.

### a) Number-of-Inflows Calculation Unit 102

With reference to FIG. 3, the number-of-inflows calculation unit 102 initializes the variable Cin and the variable IX to 0 (step 150). The number-of-inflows calculation unit 102 further initializes the storage areas in the number-of-inflows storage unit 104 (step 152). Next, the number-of-inflows calculation unit 102 acquires the current time (step 154). Furthermore, the number-of-inflows calculation unit 102 determines whether or not the current time acquired in step 154 has exceeded the boundary of the predetermined time interval described above, and causes the flow of the control to diverge according to the result of the determination (step 156). Immediately after the activation of the program, the current time has not yet been set. Therefore, the determination in step 156 is positive, and the control proceeds to step 158.

The number-of-inflows calculation unit 102 stores the value of the variable Cin (0 at this point in time) in the area (0) in the number-of-inflows storage unit 104 (step 158). Thereafter, the number-of-inflows calculation unit 102 adds 1 to the value of the variable IX. As a result, the value of the variable IX becomes 1. Furthermore, the number-of-inflows calculation unit 102 subjects the variable IX to a modulo operation with the constant MAX=24, and updates the value of the variable IX according to the result of the modulo operation (step 160). As a result, the value of the variable IX becomes 1. The number-of-inflows calculation unit 102 clears the value of the variable Cin to 0 (step 162).

Furthermore, the number-of-inflows calculation unit 102 determines whether or not a signal indicating that an inflow vehicle is detected has been received from the vehicle detector 70 via the reception unit 100 (step 164). When receiving a signal indicating that an inflow vehicle is detected, the number-of-inflows calculation unit 102 adds 1 to the value of the variable Cin (step 166). Thereafter, the control returns to step 154. If the determination in step 164 is negative, step 166 is not executed and the control immediately returns to step 154.

Thereafter, the above processing is repeated. The determination in step 156 is negative until the predetermined time interval elapses during execution of the repetition. Therefore, if a vehicle detection signal is received, 1 is added to the value of the variable Cin in step 166, and if a vehicle detection signal is not received, the value of the variable Cin remains unchanged.

When the predetermined time interval has elapsed, the determination in step 156 becomes positive. The value of the variable Cin is stored in the area (IX) (step 158). 1 is added to the variable IX, division with modulo MAX is executed, and the variable IX is updated according to the result of the division. As a result, each time the predetermined time interval elapses, the variable IX increases from 0 to 23 and returns to 0, repeatedly. In addition, the value of the number of inflow vehicles counted during the predetermined time interval is stored in the storage area indicated by the variable IX before the update. Thus, the number-of-inflows storage unit 104 operates as a ring buffer, and the number of inflow vehicles for the most recent, past one cycle period, divided into 5-second intervals, is always stored in the number-of-inflows storage unit 104.

### b) Number-of-Outflows Calculation Unit 106

The operation of the number-of-outflows calculation unit 106 is also similar to that of the number-of-inflows storage unit 104. However, the operation of the number-of-outflows calculation unit 106 is different from the operation of the number-of-inflows storage unit 104 in that the input signal is a detection signal of an outflow vehicle from the vehicle detector 74, and the number of outflow vehicles for the most recent one cycle period is stored for each 5 seconds in the number-of-outflows storage unit 108.

### c) Signal Control Unit 110

When the signal control server 68 is activated, the program for the signal control unit 110 having the control configuration shown in FIG. 7 is activated for each one cycle period. The signal control unit 110 acquires the current time at the beginning of each period (step 250). Furthermore, the signal control unit 110 reads out the number of inflows in the most recent past unit time (120 seconds) from the number-of-inflows storage unit 104 (step 252). The signal control unit 110 reads out all the numbers of inflows stored in the number-of-inflows storage unit 104 and calculates their sum, thereby calculating the number of inflow vehicles in the most recent past unit time (120 seconds).

Furthermore, as in step 252, the signal control unit 110 reads out the number of outflow vehicles in the past unit time from the number-of-outflows calculation unit 106 (step 254). The signal control unit 110 calculates a difference between the number of inflow vehicles obtained in step 252 and the number of outflow vehicles obtained in step 254 (step 256). The signal control unit 110 causes the flow of the control to diverge according to whether or not the difference calculated in step 256 is equal to or larger than a predetermined threshold value (step 258).

When the determination in step 258 is positive, the signal control unit 110 determines that the first-direction road 54 is congested. As a result, the signal control unit 110 executes the processes in step 260 and subsequent steps. When the determination is negative, the signal control unit 110 tentatively determines that the first-direction road 54 is not congested. However, the signal control unit 110 operates as follows just in case.

That is, in this case, the signal control unit 110 attempts to acquire the vehicle state on the connection area 80 (see FIG. 1) between the first-direction road 54 and the rampway 60 (step 274). Specifically, in step 274, the signal control unit 110 determines whether or not probe information has been received from any probe vehicle, and if probe information has been received, determines whether or not the position of the probe vehicle is inside the connection area 80. The signal control unit 110 determines whether or not the vehicle state has been received, based on the result of the process in step 274, and causes the flow of the control to diverge according to the result of the determination (step 276). If the determination in step 276 is positive, the signal control unit 110 further determines whether or not the vehicle state satisfies the congestion condition, and causes the flow of the control to diverge according to the result of the determination (step 278). If the determination in step 278 is positive, the signal control unit 110 determines that the first-direction road 54 is congested, even though it was determined in step 258 that the first-direction road 54 is not congested. As a result, the signal control unit 110 executes the processes in step 260 and subsequent steps.

On the other hand, when the determination in step 276 or the determination in step 278 is negative, the signal control unit 110 determines that the first-direction road 54 is not congested. As a result, the control proceeds to step 280. In this case, the signal control unit 110 sets the signal parameters for the traffic signal 62 to fixed-cycle parameters prepared in advance (step 280). Finally, the signal control unit 110 transmits the signal parameters to the traffic signal 62 (step 272) to end execution of the program in this cycle.

In contrast, when the determination in step 258 is positive and the determination in step 278 is positive, the signal control unit 110 estimates a queue length as an index indicating congestion on the rampway 60 (step 260). Subsequently, the signal control unit 110 attempts to acquire probe information from a probe vehicle present on the rampway 60 (step 262). When probe information from a probe vehicle present on the rampway 60 has been obtained as the result of the process in step 262 (the determination in step 264 is positive), the signal control unit 110 corrects the queue length estimated in step 260 by using the probe information obtained in step 262 (step 266). When the determination in step 264 is negative, the signal control unit 110 does not perform the process in step 266, and uses the queue length estimated in step 260 as it is for the subsequent processes.

Furthermore, the signal control unit 110 acquires the congestion state on the general road 58 on the intersecting side from information from the vehicle detector installed on the general road 58 (step 268). The signal control unit 110 calculates signal parameters according to a method similar to the ordinary actuated control, by using the information obtained in the processes in steps 262 to 268 (step 270). The signal control unit 110 transmits the calculated signal parameters to the traffic signal 62 to end execution of the program in this cycle (step 272).

As described above, in the present embodiment, even when a vehicle detector is not installed on the rampway, the degree of congestion on the rampway can be determined if a vehicle detector is present on the upstream side or the downstream side of the main road, or on both sides. Therefore, even on the rampway where a vehicle detector cannot be installed, a traffic signal installed at the exit of the rampway can be controlled as an actuated traffic signal. A queue length as an index of the degree of congestion on the rampway is estimated based on the degree of congestion on the main road. Information for controlling the traffic signal at the exit of the rampway as an actuated traffic signal can be generated without necessity of installing a vehicle detector on the rampway. It is conceivable that there is a correlation between the number of inflow vehicles per unit time into a predetermined section and the number of vehicles on the rampway. Therefore, the degree of congestion on the rampway can be estimated from the number of inflow vehicles. Based on a difference between the number of inflow vehicles into the predetermined section and the number of outflow vehicles from the predetermined section, the number of vehicles that have entered the rampway from the main road can be estimated with high reliability. Based on the result of the estimation, the degree of congestion on the rampway can be estimated with high reliability. It is conceivable that there is also a correlation between the number of outflow vehicles counted by a vehicle detector installed on the downstream side, and the number of vehicles that enter the rampway. Therefore, the degree of congestion on the rampway can be estimated by using the output of the downstream-side vehicle detector installed on the main road, without installing a vehicle detector on the rampway.

When a probe vehicle is present in the connection area where the rampway branches off from the main road, the moving speed, the stop time, etc., of a vehicle present near the connection area can be estimated based on probe information obtained from the probe vehicle. These have a strong correlation with the degrees of congestion on the main road and the rampway. Therefore, the degrees of congestion on the main road and the rampway can be estimated by using the probe information, and the reliability of the estimation is enhanced. If a probe vehicle is present on the rampway, a queue length on the rampway can be estimated by using probe information of the probe vehicle. By correcting the queue length using the estimated value, the reliability in estimating the degree of congestion on the rampway can be enhanced. Using the result of the estimation and the traffic condition on the general road, signal parameters are generated. As a result, the traffic signal installed at the exit of the rampway can be appropriately controlled according to the conditions on both the rampway and the general road. If the predetermined section has a plurality of lanes, a vehicle attempting to enter the rampway should have moved to a lane on the rampway side before entering the rampway. Therefore, there is a correlation between the degree of congestion of vehicles on the rampway-side lane, and the degree of congestion on the rampway. The traffic condition on the rampway can be estimated by using the output of the vehicle detector for the rampway-side lane of the main road. As a result, the traffic condition on the rampway can be estimated without installing a vehicle detector on the rampway.

If the unit time is too long, appropriate signal control cannot be performed. Meanwhile, if the unit time is shorter than one period, the operation of the traffic signal will change before one cycle of the traffic signal is completed, which is undesirable. Therefore, the unit time is preferably equal to or shorter than two periods and equal to or longer than one period of the cycle of the traffic signal, for example, is equal to two periods or one period. The unit time may be a time equal to one period of the cycle of a traffic signal at a signalized intersection. By making the unit time equal to one period of the cycle of the traffic signal, it is possible to quickly respond to a change in the traffic volume. Moreover, the operation of the traffic signal will not change in the middle of the cycle.

In the above embodiment, using the downstream-side vehicle detector, the degree of congestion on the main road is estimated based on a difference between the number of inflow vehicles detected by the upstream-side vehicle detector and the number of inflow vehicles detected by the downstream-side vehicle detector. Furthermore, the degree of congestion on the rampway is estimated based on the degree of congestion on the main road estimated as described above. However, the present disclosure is not limited to the embodiment. It is conceivable not to use the downstream-side vehicle detector. Generally, it is considered that there is a certain relationship (e.g., proportional relationship) between vehicles entering a certain section, of a road, having a rampway formed in the middle of the road, and vehicles exiting the certain section. Therefore, it is possible to estimate a difference between the number of inflow vehicles and the number of outflow vehicles by simply counting the number of inflow vehicles into the section, and multiplying the value by a certain ratio. That is, instead of step 254 and step 256 shown in FIG. 7, a step in which the number of inflow vehicles read out in step 252 is multiplied by a predetermined coefficient to obtain an estimated value of a difference between the number of inflow vehicles and the number of outflow vehicles, may be introduced. If it is statistically known that the ratio changes depending on the type of day, time of day, etc., the coefficient may be changed according to the type of day, time of day, etc.

Using similar logic, it is also possible to use the output of the downstream-side vehicle detector without using the upstream-side vehicle detector.

Furthermore, it is considered that a vehicle entering the rampway from the main road is usually traveling on the leftmost lane (in the case of Japan) in preparation for that. Considering this reality, it is also possible to realize a function similar to that of the above embodiment by using both, or only one of, the number of vehicles entering the section including the rampway via the leftmost lane and the number of vehicles exiting from the section via the leftmost lane. In this case, the vehicle detector used in the above embodiment may be limited to the leftmost one. In countries or regions where vehicles travel on the right side, only the rightmost vehicle detector is used.

Moreover, in the above embodiment, firstly, the degree of congestion on the main road is estimated based on the output of the vehicle detector, and only when it is determined that the main road is not congested (determination in step 258 is negative), determination on the degree of congestion using the probe vehicle is performed (step 274 to step 278). However, the present disclosure is not limited to the embodiment. Determination on the degree of congestion on the main road may be performed by only the processes in steps 274 to 278 without performing determination based on the output of the vehicle detector. This method is particularly effective when the number of probe vehicles reaches a certain percentage or more. In addition, the method of using only the upstream-side vehicle detector or only the downstream-side vehicle detector can be combined with the case of using the probe information. The same applies to the case of using only the vehicle detector on the leftmost lane.

### 2. Second Embodiment

### 2.1) Configuration

### a) Overall Configuration

In the first embodiment, both the vehicle detector installed on the upstream side of the rampway and the vehicle detector installed on the downstream side of the rampway are used. The outputs of these vehicle detectors are used to estimate the degree of congestion on the main road, and the result of the estimation is used to estimate the degree of congestion on the rampway. In such processing, estimation of the degree of congestion on the rampway may lag behind the actual degree of congestion on the rampway. That is, even when the rampway starts to become congested, this will be revealed after one cycle elapses from when the number of inflow vehicles into the section is revealed. Therefore, there is a possibility that change in signal parameters may also be delayed by one cycle. The second embodiment takes such a possibility into consideration.

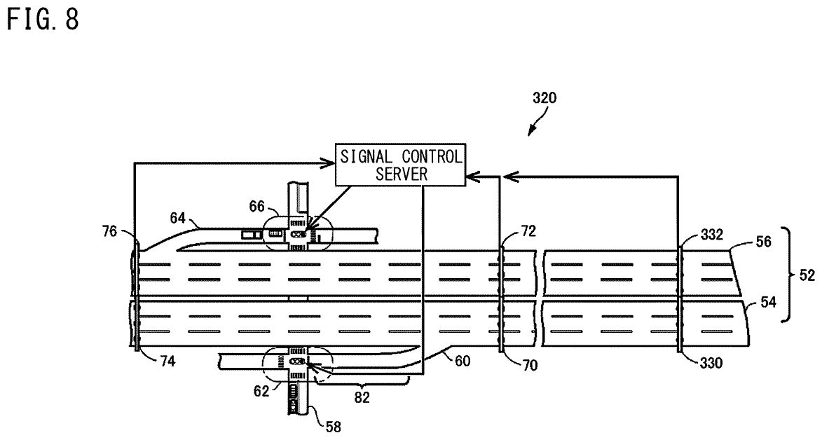

FIG. 8 shows the overall configuration of a signal control system 320 according to the second embodiment. In FIG. 8, the motor highway 52 shown in FIG. 1 is extended to the right, up to the vicinity of an upstream vehicle detector 330 located further upstream than the vehicle detector 70. A vehicle detector 332 is also installed on the second-direction road 56 at the same position as the upstream vehicle detector 330. However, the vehicle detector 332 has no direct relationship with this embodiment.

The signal control system 320 includes a signal control server 334 instead of the signal control server 68 shown in FIG. 1. The signal control server 334 receives vehicle detection signals not only from the vehicle detector 70 and the vehicle detector 74 but also from the upstream vehicle detector 330 located further upstream than the vehicle detector 70, and estimates the degree of congestion on the first-direction road 54 in the section between the vehicle detector 70 and the vehicle detector 74. In all other respects, the signal control system 320 has the same configuration as the signal control system 50 according to the first embodiment. In the following description, the number of inflow vehicles detected by the upstream vehicle detector 330 is referred to as “upstream-side number of inflow vehicles” or “upstream-side number of inflows”.

### b) Signal Control Server 334

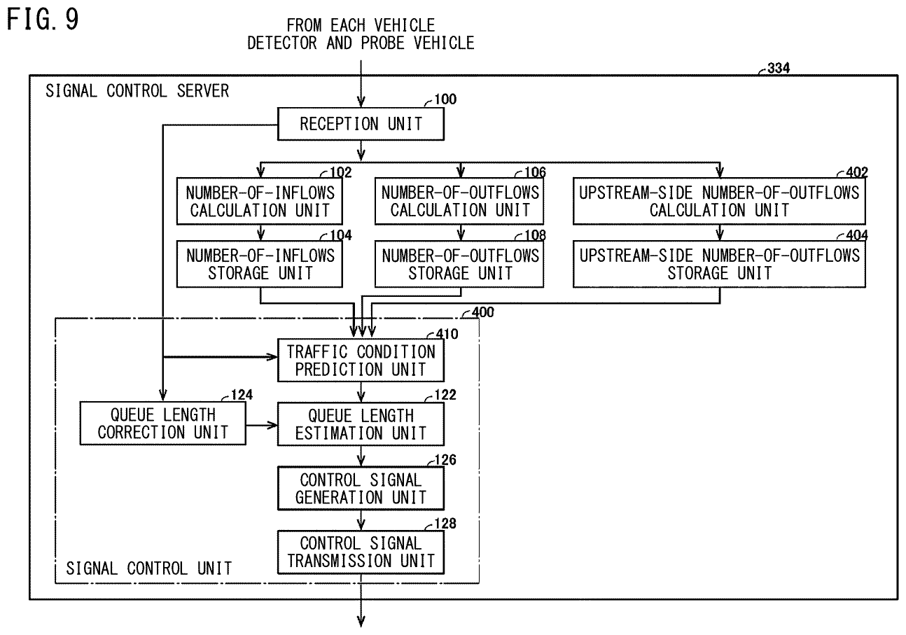

With reference to FIG. 9, the signal control server 334 according to the second embodiment is different from the signal control server 68 according to the first embodiment in that it includes an upstream-side number-of-inflows calculation unit 402 and an upstream-side number-of-inflows storage unit 404 having the same functions as the number-of-inflows calculation unit 102 and the number-of-inflows storage unit 104. The upstream-side number-of-inflows calculation unit 402 calculates the upstream-side number of inflow vehicles passing through the upstream vehicle detector 330, for each predetermined time interval, in response to the vehicle detection signal from the upstream vehicle detector 330. The upstream-side number-of-inflows storage unit 404 stores the upstream-side number of inflow vehicles calculated by the upstream-side number-of-inflows calculation unit 402, for each predetermined time interval.

The signal control server 334 is different from the signal control server 68 according to the first embodiment in that it includes a signal control unit 400 instead of the signal control unit 110 of the signal control server 68. The signal control unit 400 is connected to the number-of-inflows storage unit 104, the number-of-outflows calculation unit 106, and the upstream-side number-of-inflows storage unit 404, generates a control signal for the traffic signal 62 based on the number of inflow vehicles, the number of outflow vehicles, and the upstream-side number of inflow vehicles stored in these storage units, and on, if any, probe information received by the reception unit 100, and transmits the control signal to the traffic signal 62. The other function units (reception unit 100, number-of-inflows calculation unit 102, number-of-inflows storage unit 104, number-of-outflows calculation unit 106, and number-of-outflows storage unit 108) are the same as those of the first embodiment.

The signal control unit 400 is different from the signal control unit 110 shown in FIG. 1 in that it includes a traffic condition prediction unit 410 instead of the traffic condition estimation unit 120. The traffic condition prediction unit 410 predicts the congestion state in the next cycle on the main road, i.e., the first-direction road 54, based on the number of inflows in the most recent past unit time stored in the number-of-inflows storage unit 104, the number of outflows in the most recent past unit time stored in the number-of-outflows storage unit 108, the upstream-side number of inflows in the most recent past unit time stored in the upstream-side number-of-inflows storage unit 404, and on, if any, probe information received through the reception unit 100. The other function units of the signal control unit 400 are the same as the corresponding function units in the signal control unit 110.

### b1) Traffic Condition Prediction Unit 410

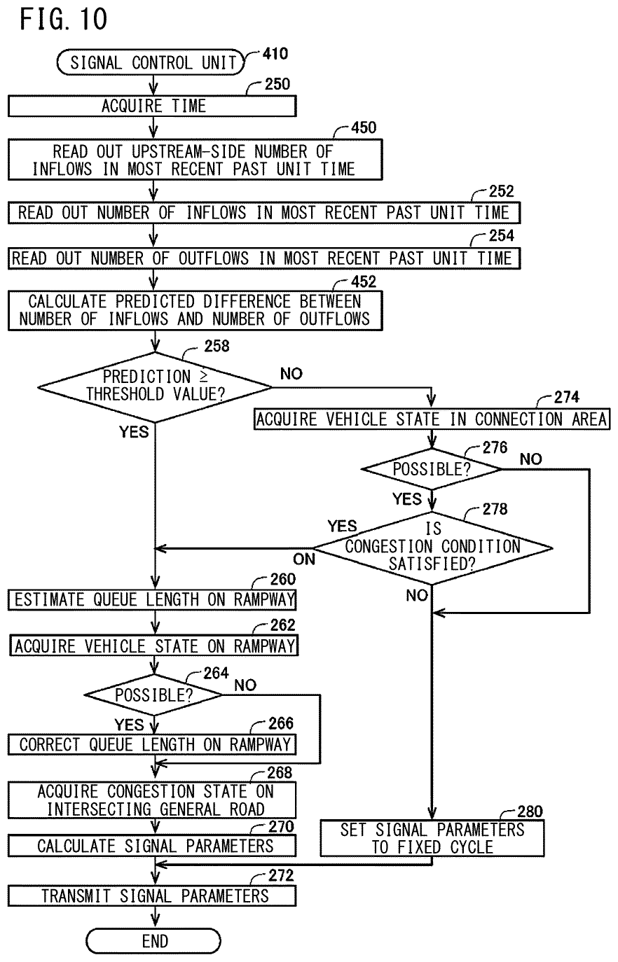

FIG. 10 is a flowchart showing a control configuration of a program that realizes the traffic condition prediction unit 410. With reference to FIG. 10, this program has substantially the same configuration as that shown in FIG. 7, but is different from that shown in FIG. 7 in that the program includes: step 450, between step 250 and step 252, of reading out the upstream-side number of inflows in the most recent past unit time from the upstream-side number-of-inflows storage unit 404; and step 452, instead of step 256 in FIG. 7, of predicting a difference between the number of inflows and the number of outflows in the section between the vehicle detector 70 and the vehicle detector 74, based on the information read out in step 450, step 252, and step 254, and outputting the predicted difference. The other process steps have the same contents as those shown in FIG. 7.

In step 450, the traffic condition prediction unit 410 reads out the most recent upstream-side number of inflows in the past which is stored in the aforementioned upstream-side number-of-inflows storage unit 404. The upstream-side number of inflows is, so to speak, a value that anticipates the number of inflows to be detected by the vehicle detector 70. Therefore, using the upstream-side number of inflows makes it possible to predict a difference between the number of inflow vehicles and the number of outflow vehicles in the next cycle. Based on the predicted difference, signal parameters suitable for the actual number of vehicles, which exit the rampway 60 onto the general road 58, can be calculated without any time delay.

The difference is predicted in step 452. Assuming that another rampway does not exist between the upstream vehicle detector 330 and the vehicle detector 70, all the vehicles detected by the upstream vehicle detector 330 are detected by the vehicle detector 70. However, there is a time lag therebetween, and the time lag varies depending on the vehicle speed. However, assuming that the vehicle speed follows a certain distribution (e.g., normal distribution), there will be no significant error even if all the vehicles are considered to reach the vehicle detector 70 at a speed obtained by averaging the speeds at which the vehicles were detected. As a result, it may be considered that all the vehicles passing through the upstream vehicle detector 330 will reach the vehicle detector 70 after a certain time. This certain time depends on the distance between the upstream vehicle detector 330 and the vehicle detector 70. However, this time is considered to vary depending on the type of day, time of day, weather, etc.

Therefore, in the embodiment, as for the number of inflow vehicles for predicting the difference in step 452, the number of inflow vehicles into the section is the weighted average of the number of vehicles detected by the upstream vehicle detector 330 and the number of vehicles detected by the vehicle detector 70 in the same unit time. Using the same concept, the number of outflow vehicles from the section is the weighted average of the number of vehicles detected by the vehicle detector 70 and the number of vehicles detected by the vehicle detector 74 in the same unit time. The difference between the predicted number of inflow vehicles and the predicted number of outflow vehicles is a prediction of a difference (predicted difference) that will be detected in the next cycle. In subsequent processing, this predicted difference is used instead of the difference in the first embodiment.

The weighting value used in the weighted average of the upstream-side number of inflow vehicles and the number of inflow vehicles varies depending on the distance between the upstream vehicle detector 330 and the vehicle detector 70. For example, when the distance between the upstream vehicle detector 330 and the vehicle detector 70 is large, it is appropriate to make the weighting on the upstream-side number of inflows smaller than when the distance is small. The same applies to the weighting value used in the weighted average of the number of inflow vehicles and the number of outflow vehicles.

### 2.2) Operation

The signal control server 334 according to the second embodiment operates as follows. Each of the upstream vehicle detector 330, the vehicle detector 70, and the vehicle detector 74 detects a vehicle passing through it, and transmits a detection signal to the signal control server 334.

Each of the upstream-side number-of-inflows calculation unit 402, the number-of-inflows calculation unit 102, and the number-of-outflows calculation unit 106 in the signal control server 334 calculates and stores the number of detected vehicles for each predetermined time interval in response to the corresponding signal.

When the program shown in FIG. 10 has been activated, the upstream-side number of inflow vehicles, the number of inflow vehicles, and the number of outflow vehicles are read out in step 450, step 252, and step 254, respectively. In step 452, a predicted difference between the number of inflow vehicles and the number of outflow vehicles in the next cycle is calculated by using these numerical values. Using the predicted difference, the processes in step 258 and subsequent steps are executed as in the first embodiment. Based on the result, next signal parameters are calculated to be used for controlling the traffic signal 62.

As described above, according to the present embodiment, the number of inflow vehicles and the number of outflow vehicles in the next cycle are predicted by using the vehicle detection signal of the upstream vehicle detector 330, and signal parameters in the next cycle are calculated according to the result of the prediction. As a result, in the next cycle, the traffic signal can be controlled with the signal parameters according to the actual degree of congestion on the main road and the actual degree of congestion on the rampway 60. As a result, even if it is difficult to install a vehicle detector on the rampway 60, the traffic signal at the exit of the rampway 60 can be controlled as an actuated traffic signal by using the vehicle detector existing on the main road. The number of vehicles that will enter the predetermined section in the future can be estimated based on the output of the upstream vehicle detector that is located further upstream than the vehicle detector installed on the upstream side. By correcting the output of the vehicle detector installed on the upstream side with this value, the degree of congestion on the main road can be predicted using the predicted number of vehicles as well as the number of vehicles that enter the predetermined section. Since the degree of congestion on the rampway is estimated using the degree of congestion on the main road, the delay in estimating the degree of congestion can be reduced, thereby generating more appropriate signal parameters.

In the program shown in FIG. 10, step 252, step 254, and step 450 may be in any order as long as the steps are between step 250 and step 452.

### 3. Implementation by Computer

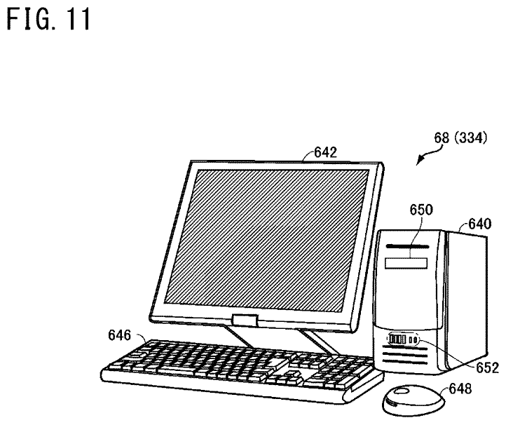

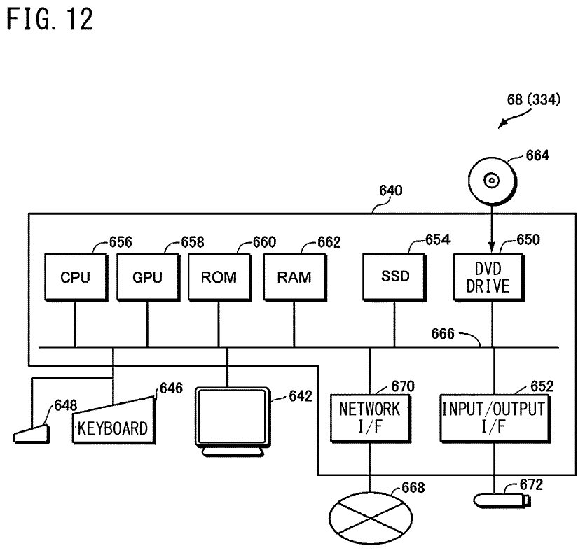

The signal control server 68 according to the first embodiment and the signal control server 334 according to the second embodiment each are implemented by computer hardware including a processor, a program executed by the computer hardware, and data stored in the computer hardware. FIG. 11 shows an appearance of a computer system implementing the signal control server 68, for example, and FIG. 12 shows the internal configuration of the computer system shown in FIG. 11. The same applies to the signal control server 334.

With reference to FIG. 11, the signal control server 68 includes a computer 640 having a DVD (Digital Versatile Disc) drive 650 and an input/output I/F (Interface) 652, a keyboard 646, a mouse 648, and a monitor 642.

With reference to FIG. 12, in addition to the DVD drive 650, the computer 640 includes a CPU (Central Processing Unit) 656, a GPU (Graphics Processing Unit) 658, a bus 666 that is connected to the CPU 656, the GPU 658, and the DVD drive 650, a ROM (Read-Only Memory) 660 that stores a boot-up program, etc., a RAM (Random Access Memory) 662 that is connected to the bus 666 and stores program instructions at the time of execution, system programs, working data, etc., and an SSD (Solid State Drive) 654 that is a non-volatile memory. The computer 640 further includes a network I/F 670 that provides a connection to a network 668 that enables communication with other terminals. The network I/F 670 can receive a signal from each vehicle detector via the network 668, and transmit signal parameters to the signal control device of the traffic signal 62. Although not shown in FIG. 12, the computer 640 may be provided with a wireless communication device connected to the network 668 via a mobile phone network, instead of the network I/F 670.

In each of the above embodiments, the variables Cin, Cout, and IX, as well as the constant MAX are all stored in the RAM 662 shown in FIG. 12. The number-of-inflows storage unit 104, the number-of-outflows storage unit 108, and the upstream-side number-of-inflows storage unit 404 shown in FIG. 4, FIG. 6, and FIG. 9, respectively, are provided as storage areas in the SSD 654.

The program for operating this computer system as the signal control server 68 and the functions of the components of the signal control server 68 is stored in a DVD 664 mounted in the DVD drive 650, and is transferred from the DVD drive 650 to the SSD 654. Alternatively, the program may be stored in a portable memory 672 and transferred to the SSD 654 via the input/output I/F 652. Furthermore, the program may be transmitted to the computer 640 via the network 668 and stored in the SSD 654. The program is loaded into the RAM 662 when executed. The program may be directly loaded into the RAM 662 from the DVD 664 or the portable memory 672, or via the network 668 and the network I/F 670.

This program includes a plurality of instructions that cause the computer 640 to operate as the signal control server 68 according to the above embodiment. Some of the basic functions necessary to realize the operation are provided by an operating system (OS) that operates on the computer 640 or a third-party program, or by modules of various tool kits installed in the computer 640. Therefore, this program may not necessarily include all functions required to realize the system and method according to the embodiment. The program may include, out of the above instructions, only the instructions that execute the operations as the signal control server 68 and the components thereof, by calling appropriate functions or “programming tool kits” under a controlled manner to attain desired results. Since the operation of the computer 640 is well known, description will not be given here. The GPU 658 is capable of parallel processing, and can execute functions for controlling many traffic signals in parallel.

The signal control server 68 and the signal control server 334 may be implemented not by a single computer but by a plurality of computers capable of operating in parallel, and some or all of their functions may be placed in a so-called cloud. In this case, even if the hardware that implements some functions such as the signal control system 50 described above is located outside the territory of this country, the system is included in the scope of this disclosure as long as it is provided within this country accordingly.

The processes (functions) of the above-described embodiments are realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU, a GPU, a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

### 4. Additional Notes

(1) A computer-readable non-transitory storage medium having stored therein a computer program that causes a computer to function as:
a main road congestion degree estimation unit configured to estimate a degree of congestion on a predetermined section of a main road; and
a queue length estimation unit configured to, based on the degree of congestion estimated by the congestion degree estimation unit, estimate a queue length on a rampway that branches off from the main road toward a signalized intersection leading to another road.
(2) A queue length estimation method comprising the steps of:
estimating a degree of congestion on a predetermined section of a main road; and
based on the degree of congestion estimated in the step of estimating the degree of congestion, estimating a queue length on a rampway that branches off from the main road toward a signalized intersection leading to another road.
(3) A signal control method comprising the steps of:
estimating a degree of congestion on a predetermined section of a main road;
based on the degree of congestion estimated in the step of estimating the degree of congestion, estimating a queue length on a rampway that branches off from the main road toward a signalized intersection leading to another road; and
based on the queue length estimated in the step of estimating the queue length, controlling a period or a split of a phase of a traffic signal installed in the signalized intersection.

The embodiments disclosed herein are merely illustrative in all aspects and should be considered not restrictive. The scope of this disclosure is defined by the scope of the claims rather than the detailed description of the disclosure, and is intended to include meaning equivalent to the scope of the claims and all modifications within the scope.

### REFERENCE SIGNS LIST

50, 320 signal control system
52 motor highway
54 first-direction road
56 second-direction road
58 general road
60, 64 rampway
62, 66 traffic signal
68, 334 signal control server
70, 72, 74, 76, 332 vehicle detector
80 connection area
82 queue of retention vehicles
84, 86 probe vehicle
100 reception unit
102 number-of-inflows calculation unit
104 number-of-inflows storage unit
106 number-of-outflows calculation unit
108 number-of-outflows storage unit
110, 400 signal control unit
120 traffic condition estimation unit
122 queue length estimation unit
124 queue length correction unit
126 control signal generation unit
128 control signal transmission unit
330 upstream vehicle detector
402 upstream-side number-of-inflows calculation unit
404 upstream-side number-of-inflows storage unit
410 traffic condition prediction unit
640 computer
642 monitor
646 keyboard
648 mouse
650 DVD drive
652 input/output I/F
654 SSD
656 CPU
658 GPU
660 ROM
662 RAM
664 DVD
666 bus
668 network
670 network I/F
672 portable memory

1. An information processing device, comprising:
a main road congestion degree estimation unit configured to estimate a degree of congestion on a predetermined section of a main road; and
a queue length estimation unit configured to, based on the degree of congestion estimated by the main road congestion degree estimation unit, estimate a queue length on a rampway that branches off from the main road toward a signalized intersection leading to another road.

2. The information processing device according to claim 1, wherein
the main road congestion degree estimation unit includes a unit time congestion degree estimation unit configured to, based on at least the number of inflow vehicles per unit time into the predetermined section, estimate the degree of congestion on the predetermined section in each unit time.

3. The information processing device according to claim 2, wherein
the unit time congestion degree estimation unit includes:
a number-of-inflows calculation unit configured to calculate the number of inflow vehicles into the predetermined section in each unit time;
a number-of-outflows calculation unit configured to calculate the number of outflow vehicles from the predetermined section in each unit time; and
a section congestion degree estimation unit configured to estimate the degree of congestion on the predetermined section, based on a difference between the number of inflow vehicles per unit time calculated by the number-of-inflows calculation unit and the number of outflow vehicles per unit time calculated by the number-of-outflows calculation unit.

4. The information processing device according to claim 3, wherein
the number-of-inflows calculation unit calculates the number of inflow vehicles into the predetermined section in each unit time, based on an output of a vehicle detector installed on an upstream side with respect to the predetermined section.

5. The information processing device according to claim 4, wherein
the number-of-inflows calculation unit calculates a predicted number of inflow vehicles into the predetermined section in each unit time, based on, in addition to the output of the vehicle detector installed on the upstream side, an output of an upstream vehicle detector that is installed further upstream than the vehicle detector installed on the upstream side.

6. The information processing device according to claim 3, wherein
the number-of-outflows calculation unit calculates the number of outflow vehicles from the predetermined section in each unit time, based on an output of a vehicle detector installed on a downstream side with respect to the predetermined section.

7. The information processing device according to claim 1, wherein
the main road congestion degree estimation unit further comprises a connection area congestion degree estimation unit configured to determine that the main road is congested, based on the state of a first probe vehicle in a connection area where the rampway branches off from the main road.

8. The information processing device according to claim 1, further comprising a rampway queue length correction unit configured to correct a queue length on the rampway, based on vehicle state information of a second probe vehicle present on the rampway.

9. The information processing device according to claim 1, further comprising a signal control unit configured to control a period or a split of a phase of a traffic signal, based on the queue length estimated by the queue length estimation unit.

10. The information processing device according to claim 9, wherein
the signal control unit controls the period or the split of the phase of the traffic signal, based on the queue length estimated by the queue length estimation unit, and a queue length on the other road at the signalized intersection.

11. The information processing device according to claim 1, wherein
the main road congestion degree estimation unit includes a rampway-side lane congestion degree estimation unit configured to estimate the degree of congestion on a lane on the rampway side in the predetermined section.

12. The information processing device according to claim 2, wherein
the unit time is a time equal to or shorter than two periods and equal to or longer than one period of a cycle of a traffic signal at the signalized intersection.

13. The information processing device according to claim 12, wherein
the unit time is a time equal to one period of the cycle of the traffic signal at the signalized intersection.

14. A signal control device, comprising:
a main road congestion degree estimation unit configured to estimate a degree of congestion on a predetermined section of a main road;
a queue length estimation unit configured to, based on the degree of congestion estimated by the main road congestion degree estimation unit, estimate a queue length on a rampway that branches off from the main road toward a signalized intersection leading to another road; and
a signal control unit configured to control a period or a split of a phase of a traffic signal, based on the queue length estimated by the queue length estimation unit.

15. A queue length estimation method, comprising the steps of:
estimating, by a computer, a degree of congestion on a predetermined section of a main road; and
based on the degree of congestion estimated in the step of estimating the degree of congestion, estimating, by the computer, a queue length on a rampway that branches off from the main road toward a signalized intersection leading to another road.

16. A signal control method, comprising the steps of:
estimating, by a computer, a degree of congestion on a predetermined section of a main road;
based on the degree of congestion estimated in the step of estimating the degree of congestion, estimating, by the computer, a queue length on a rampway that branches off from the main road toward a signalized intersection leading to another road; and
controlling, by the computer, a period or a split of a phase of a traffic signal installed in the signalized intersection, based on the queue length estimated in the step of estimating the queue length.

17. A computer program causing a computer to function as:
a main road congestion degree estimation unit configured to estimate a degree of congestion on a predetermined section of a main road; and
a queue length estimation unit configured to, based on the degree of congestion estimated by the main road congestion degree estimation unit, estimate a queue length on a rampway that branches off from the main road toward a signalized intersection leading to another road.
